(19) United States
(12) Patent Application Publication
(10) Pub. No.: US 2009/0205138 A1
(43) Pub. Date: Aug. 20, 2009

(54) Cushioning Apparatus

(76) Inventors: Feng Chen, Baton Rouge, LA (US); Alan J. Mandle, Hickory, NC (US)

Correspondence Address: ROY, KIESEL, KEEGAN & DENICOLA, 2355 DRUSILLA LANE, BATON ROUGE, LA, 70509, US

(21) Appl. No.: 12/428,848

(22) Filed: Apr. 23, 2009

Related U.S. Application Data
(63) Continuation-in-part of application No. 11/824,646, filed on Jul. 2, 2007.

(51) Int. Cl. A47C 21/00; A47C 20/02; A47C 7/18; B68G 7/06

(52) U.S. Cl. 5/691; 5/652; 5/655.9; 29/91.1

(57) ABSTRACT

An improved cushioning apparatus having a plurality of individual pockets containing an improved filler material comprising granular viscoelastic foam, said apparatus further comprising a top buffering layer for improved stability and comfort.

### CROSS-REFERENCE TO RELATED APPLICATIONS

This application is a continuation-in-part of U.S. patent application, Ser. No. 11,824,646, filed Jul. 2, 2007, which is hereby incorporated by reference in its entirety, and now abandoned.

### BACKGROUND OF THE INVENTION

1. Field of the Invention

This invention relates to bedding and seating assemblies in general and to an improved cushioning apparatus that can be permanently or detachably affixed as a cover, topper, on mattresses, chairs, stools, and the like, in particular.

2. Prior Art

Covers, toppers, pads, etc. for use on mattress, chairs, stools, sofas, benches, and the like, for protecting the underlying surface, as well as for providing enhanced user comfort, are well known in the prior art; however, there remains a need for their improvement. In the prior art, many such covers comprise filler material in the form of bulky unitary solid slabs that restrict airflow and retain heat, adversely affecting the user's comfort. Furthermore, such solid slab filler materials often give the covers the appearance of being bulky and overweight. And although there exist duvet-style covers, comprising individual pockets of filler material, that are more aesthetically pleasing and provide greater comfort, these type of covers have their own limitations. For example, the pocket filler materials often used in such duvet-style covers comprise materials such as polyester fibers or feathers which are not very pressure sensitive and do not optimally conform to a user's body contours. Therefore, an improved cushioning apparatus to serve as a topper or cover for mattresses, chair, seats, stools, and the like, and meeting the following objectives would be highly desirable in the industry.

### OBJECTS OF THE INVENTION

It is an object of the invention to provide an improved cushioning apparatus that overcomes the deficiencies in the prior part.

It is yet another object of the invention to provide an improved duvet-style cushioning apparatus having a base layer including a plurality of pockets containing an improved filler material designed to provide maximum comfort for the user.

It is yet another object of the invention to provide an improved duvet-style cushioning apparatus further having a top buffering layer for improved stability and comfort.

It is an object of the invention to provide an improved cushioning apparatus having improved filler material comprising granular viscoelastic foam.

It is another object of the invention to provide an improved cushioning apparatus that can be detachably or permanently affixed as a cover or topper on mattresses and/or box spring combinations, chairs, stools, benches and the like.

It is another object of the invention to provide an improved cushioning apparatus that can be incorporated into a mattress structure to form an integral portion thereof.

It is an object of the invention to provide an improved cushioning apparatus that is more aesthetically pleasing.

These and other objects and advantages of the invention shall become apparent from the ensuing figures and descriptions of the invention.

### SUMMARY OF THE INVENTION

A cushioning apparatus, comprising a base layer utilizing a pocket arrangement wherein the pockets are filled with non-unitary, discrete, granular viscoelastic foam to provide for greater pressure and temperature sensitivity. The cushioning apparatus will further comprise a top buffering layer situated above the pocket arrangement, said top layer providing for uniformity and stability, as well as additional comfort for the user. The cushioning apparatus of the present invention can be detachably or permanently affixed as a cover or topper on mattresses, chairs, stools, benches and the like, further being capable of incorporation into a mattress structure to thereby form an integral portion thereof.

### BRIEF DESCRIPTION OF THE FIGURES

FIG. 1 is a preferred embodiment of the cushioning apparatus of the present invention in the form of a mattress topper, with the top layer being depicted as partially peeled away to show the base layer.

FIG. 2 presents a cross sectional view of the cushioning apparatus depicting the granular viscoelastic filler material situated within the chambers of the cushioning apparatus.

FIG. 3 presents a preferred embodiment of the pockets or chambers of the cushioning apparatus of the present invention.

FIG. 4 shows a preferred embodiment of the cushioning apparatus in the form of an integral top layer of a mattress structure, and as a stool cover, respectively.

FIG. 5 shows a preferred embodiment of the granular viscoelastic filler material of the present invention.

### DETAILED DESCRIPTION OF THE PREFERRED EMBODIMENTS OF THE INVENTION

An improved duvet-design cushioning apparatus 1 to be utilized as a topper or cover for mattresses and/or box spring combinations, chairs, stools, and the like is disclosed. Although there exist a variety of different duvet designs that differ in manufacture and construction details, cushioning apparatus 1 of the present invention is not limited to a particular duvet design or duvet construction. In general, and as used herein, “duvet” refers to two pieces of any type of textile or non-woven material that are sewn together in a desired shape and provided with individual pockets or chambers having a filling. In a preferred embodiment of the invention, cushioning apparatus 1 of the present invention will comprise a base layer 100 including a plurality of pockets. A preferred construction of said base layer 100 will now be provided as follows.

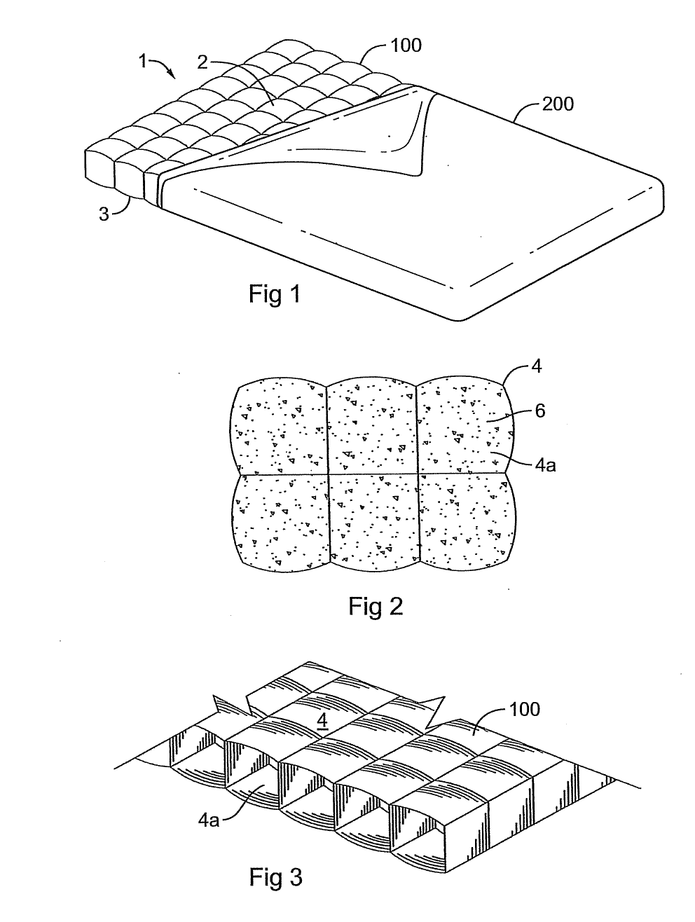

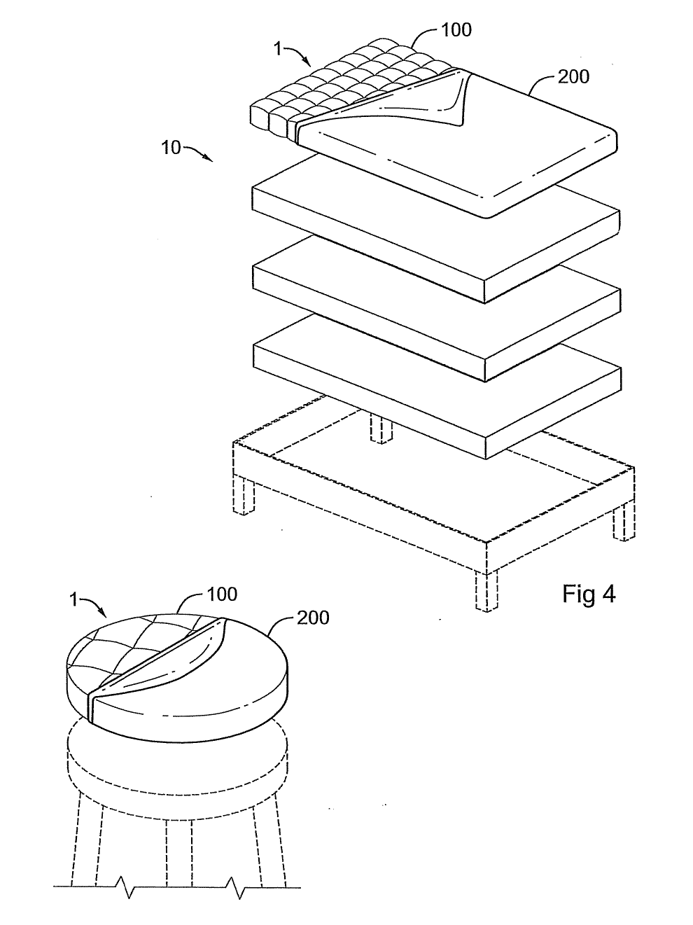

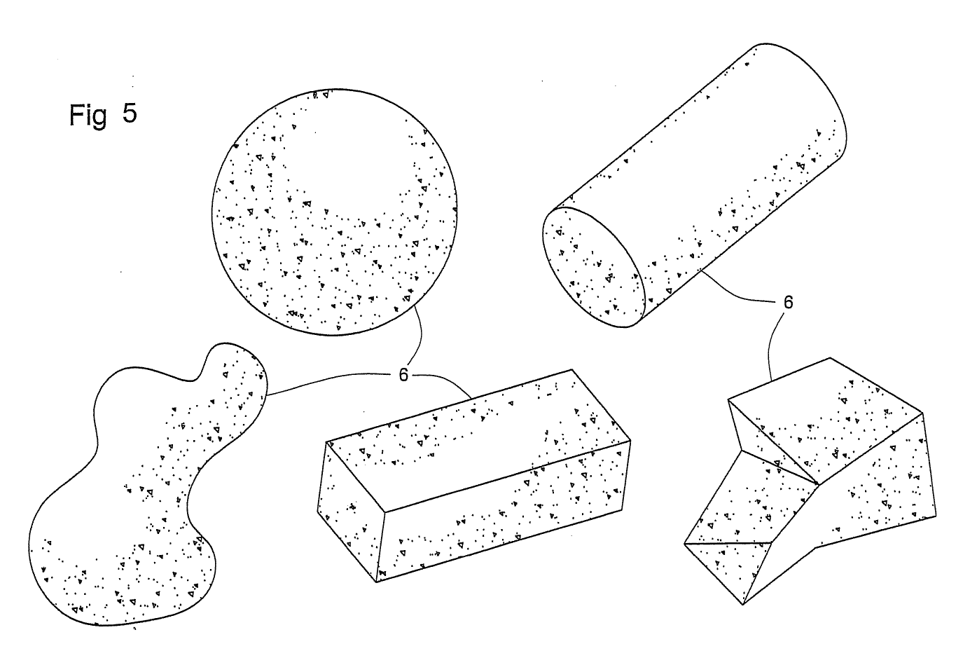

In a preferred embodiment of construction, base layer 100 comprises an upper panel 2 and a lower panel 3. Apparatus 1 may optionally comprise side panels, in accordance with desire. Upper and lower panels 2 and 3 are preferably of suitable size and configuration, e.g. round, rectangular, square, etc., to correspond to a given sleeping or sitting surface. The fabric material used to construct panels 2 and 3 will preferably be lightweight so as to minimize the weight of cushioning apparatus 1, yet at the same time, provide for resilience, flexibility, and maximum durability. In a preferred embodiment, the inventor contemplates using plain woven all cotton fabric, however other fabric materials may also be utilized. In constructing apparatus 1, panels 2 and 3 of base layer 100, and optionally side panels, are sewn to each other to form the desired structure, e.g. a square mattress topper, or a round seat cover. See FIGS. 1 and 4. Internal transverse and longitudinal seams further form a plurality of adjacent and individual chambers or pockets 4 within apparatus 1. See FIG. 3. Chambers 4 can be of any shape desired, including square, rectangular, round, triangular, diamond, as well as any other shape commonly utilized in duvet construction. In a preferred embodiment, each chamber 4 defines an internal cavity 4a designed to receive an improved filler material. See FIGS. 2 and 3. As will be discussed in more detail below, the type of filler material to be utilized, as well the state or composition of the material, is a critical factor for user comfort as well as aesthetic appearance. A plurality of unstitched areas are left for blowing in the improved filler material into internal cavities 4a of base layer 100 of cushioning apparatus 1 at various angles, as is commonly done in duvet construction, these areas subsequently being sewn closed to contain the filler material.

In a preferred embodiment, the preferred filler material of the present invention comprises viscoelastic foam 6. Viscoelastic foam 6, also known as memory foam, is a desirable filler material because it possesses pressure-sensitive and temperature-sensitive properties which allow for greater user comfort, as will be further discussed below. Viscoelastic foam is commonly available from manufacturers such as Tempurpedic, Foamex International, and Carpenter. In a further preferred embodiment, it is desired that the state or composition of the viscoelastic foam 6 be loose or granular, as opposed to unitary, the former state or composition having advantages over the latter, as also will be discussed below. This preferred composition can be achieved by shredding new viscoelastic material, or alternatively, by utilizing scrap viscoelastic material, to achieve both recycling and cost benefits.

In a preferred embodiment, discrete, granular viscoelastic foam filler material 6 will possess certain preferred properties in accordance with desire as well as intended usage of cushioning apparatus 1. For example, in one preferred embodiment, when constructing cushioning apparatus 1 as a conventional size mattress cover, a suitable density of the granular viscoelastic foam 6 would be about 4.5 pounds per cubic foot to about 5.5 per cubic foot; a suitable indentation load deflection (ILD) of the granular viscoelastic foam 6 would be about 8 pounds to about 11 pounds; and a suitable thickness of the pocket or chamber filled with the filler material would be about 1.5 inches to about 2 inches. In a further preferred embodiment, it is preferred that the viscoelastic foam pieces be generally spherical in shape, with each piece having a length (L), or longest dimension, greater than about 0.5 inches. See FIG. 5. These aforementioned preferred ranges provide for an enhanced comfort level and necessary deflection of the granular viscoelastic foam 6 to enable this comfort level.

As another example, when constructing cushioning apparatus 1 as a conventional size stool cover, a suitable density of the granular viscoelastic foam 6 would be about 1.5 lb/ft3 to about 8 lb/ft3, a suitable indentation load deflection (ILD) of the granular viscoelastic foam 6 would be about 6 lb to about 18 lb, and a suitable pocket or chamber thickness would be about 0.5 inches to about 5 inches. In a further preferred embodiment, granular viscoelastic foam 6 will comprise non-uniform pieces of various shapes, including circular, triangular, flat, oblong, etc., with each piece having a length (L) or longest dimension of about 0.078 inches to about 1.17 inches, and a width (W) or shortest dimension of about 078 inches to about 1.17 inches. See FIG. 5. Again, these preferred ranges provide for an enhanced comfort level and necessary deflection of the granular viscoelastic foam 6.

It should be noted that the filler material within chambers 4 of base layer 100 of the present invention need not consist only of granular visoelastic foam 6 and that other filler materials may also be utilized, in accordance with what is desired. For example, in one preferred embodiment, the filler material can comprise granular viscoelastic foam 6 in combination with other materials including, but not limited to, polystyrene beads, polyester fiber balls, micro denier, latex foam, polyurethane foam, feathers, cotton, as well as any other conventional filler material commonly utilized in the art. If the filler material is to be formed from a combination of granular visocelastic foam 6 with such materials, it is preferred that granular visocelastic foam 6 comprise at least about 25% of the total filler material by weight.

Base layer 100 of cushioning apparatus 1 of the present invention provides for enhanced user comfort due to the improved filler material utilized within the pocket arrangement. As mentioned above, viscoelastic filler material is the desired filler material because it possesses pressure-sensitive and temperature-sensitive properties, which allows cushioning apparatus 1 to better conform to the user's body when the user is sitting or lying down on apparatus 1. These properties are enhanced when the material is in the granular form. As apparatus 1 is comprised of granular viscoelastic foam 6, as opposed to a single thick unitary solid slab of same, this provides for more individualized areas of pressure-sensitivity, in turn allowing for a better contouring and support in response to the force exerted by the user's body. In addition, the granular composition of viscoelastic foam 6 is further beneficial as it allows for more passageways for air circulation. Viscoelastic material is generally temperature-sensitive i.e. breathable, however when viscoelastic material is in a thick sold slab form, this property is compromised as there is minimal space for air to circulate and as a result, heat flow to the outside of the material is inhibited. In contrast, when viscoelastic material is in granular form, breathability is increased, such that heat and moisture are not trapped within cushioning apparatus 1, further increasing the user's comfort. Furthermore, when the granular viscoelastic foam 6 is contained within a plurality of individual pockets or chambers 4, as is the case for apparatus 1, as opposed to being contained within in a single cavity, this provides for greater user comfort. Utilizing multiple chambers 4 allows for a pre-measured amount of the granular viscoelastic foam 6 to be evenly divided throughout apparatus 1, and thus allows for more control of the placement of the foam 6. As a result, there is less shifting of the filler material and user comfort is enhanced. Finally, the duvet design of apparatus 1 provides for an esthetically pleasing appearance, as the individual plump pockets 4 confer a more plush and luxurious look, over other types of prior art cover or topper designs.

As can be seen from the foregoing, a preferred construction of base layer 100 of apparatus 1 has been provided. In a further preferred embodiment of construction, apparatus 1 also comprises a top layer 200 overlaying base layer 100. See FIG. 1. Top layer 200 will preferably comprise a uniform slab layer of material 201 sealed to base layer 100, and will be of minimal thickness, approximately 1 inch to approximately 2 inches thick. It is preferred that top layer 200 be fire retardant, yet it need not be. It is contemplated that top layer 200 may comprise of different materials 201. For example, in one preferred embodiment, top layer 200 may comprise a slab of fiber foam. In another preferred embodiment, top layer 200 may comprise a slab of polyurethane foam. In additional preferred embodiments, top layer 200 may comprise a slab of polyester material or a slab of viscoelastic foam. Whatever the materials utilized, the primary goal is to provide a top layer 200 of uniform consistency that serves as a buffer between the user's body and the pocket arrangement of base layer 100. It is critical that top layer 200 be of minimal thickness so as not to obviate the temperature and pressure sensitivity advantages offered by the pocket arrangement of granular viscoelastic foam 6, as discussed above. In this fashion, the user will not only obtain all the advantages of the pocket arrangement of granular viscoelastic foam 6, but the user will also experience enhanced comfort and increased stability by being in contact with a uniform body of material 200. This will minimize any feelings of un-evenness and bumpiness that the user may experience, were he to be in direct contact with filler material. In addition, top layer 200 should also be kept at a minimal thickness so as not to obscure the underlying plush and luxurious pocket arrangement look of base layer 100.

In application, cushioning apparatus 1 can be utilized in a plethora of different settings in a variety of different manners. See FIGS. 1 and 4. For example, cushioning apparatus 1 can be affixed to the surface of a mattress, chair, stool etc., as a cover or topper thereof such that granular viscoelastic foam 6 is in contact with the user's body for enhanced temperature and pressure-sensitive properties, as discussed below. Cushioning apparatus 1 may be permanently affixed to the desired sleeping or sitting surface such that it forms an integral cover or topper thereof, alternatively, cushioning apparatus 1 may be detachably fitted, to the desired sleeping or sitting surface utilizing means commonly known in the art, for e.g. such as elastic straps or elastic edges to fit under the desired surface, or via mechanical devices such as hook and loop fasteners, magnetic snaps, buttons and button eyelets, etc.

As discussed above, in a preferred embodiment cushioning apparatus 1 can be utilized as a cover or topper for a given sitting or sleeping surface area. However, in another preferred embodiment, apparatus 1 can also be integrally incorporated into the mattress structure 10 itself to form a portion thereof. See FIG. 4. That is, apparatus 1, constructed in the fashion discussed above, and comprising individual pockets 4 filled with an improved granular viscoelastic foam filler material 6, can be incorporated within the framework of a conventional foam and/or spring design mattresses containing slab layers of polyurethane foam, latex foam, viscoelastic foam, etc., as well as any combinations of the foregoing, to form an integral top-layer and/or sub-layer thereof. For example, such a preferred mattress structure 10 could be constructed to have apparatus 1 as a top layer, i.e. an integral, duvet-design top-layer comprising granular viscoelastic foam 6 for breathability and responsive contouring to user-body movements; a first slab layer of high-density viscoelastic foam for additional contouring; a second slab layer of firm, high-resilience polyurethane foam, and a third and firmer slab layer of high-resilience polyurethane slab for support. In such a scenario, and assuming cushioning apparatus 1 to be a conventional size mattress layer, a suitable density of the granular viscoelastic foam 6 would be about 4 lb/ft3 to about 6 lb/ft3, a suitable indentation load deflection (ILD) of the granular viscoelastic foam 6 would be about 8 lb to about 14 lb, and a suitable pocket or chamber thickness due to the filler material would be about 2 inches to about 4 inches, with granular viscoelastic foam 6 including non-uniform pieces of various shapes having a length (L) or longest dimension of about 0.39 inches to about 1.17 inches, and having a width (W) or shortest dimension of about 0.39 inches to about 1.17 inches.

While the invention has been described in terms of its preferred embodiment, other embodiments will be apparent to those of skill in the art from a review of the foregoing. Those embodiments as well as the preferred embodiments are intended to be encompassed by the scope and spirit of the following claims.

I claim:

1. A cushioning apparatus comprising:
a. a base layer comprising a plurality of baffled chambers;
b. wherein each chamber defines an internal cavity having filler material comprising granular viscoelastic foam;
c. a top buffer layer comprising a uniform slab of material affixed to the base layer.

2. A cushioning apparatus according to claim 1, wherein the top buffer layer has a thickness between about 1 inch and about 2 inches.

3. A cushioning apparatus according to claim 1, wherein the top buffer layer comprises a slab of fiber foam.

4. A cushioning apparatus according to claim 1, wherein the top buffer layer comprises a slab of polyurethane foam.

5. A cushioning apparatus according to claim 1, wherein the top buffer layer comprises a slab of polyester material.

6. A cushioning apparatus according to claim 1, wherein the top buffer layer comprises a slab of viscoelastic foam.

7. A cushioning apparatus according to claim 1, wherein the apparatus is configured to be detachably affixed to a desired sitting surface.

8. A cushioning apparatus according to claim 1, wherein the apparatus configured to be permanently affixed to a desired sitting surface.

9. A cushioning apparatus according to claim 1, wherein the apparatus is configured to be detachably affixed to a mattress surface.

10. A cushioning apparatus according to claim 1, wherein the apparatus is configured to be permanently affixed to a mattress surface.

11. A cushioning apparatus according to claim 1, wherein the apparatus is configured to be permanently affixed within a mattress structure as an integral layer thereof.

12. A cushioning apparatus according to claim 1, wherein the granular viscoelastic foam has a density between about 1.5 pounds per cubic foot and about 8 pounds per cubic foot.

13. A cushioning apparatus according to claim 1, wherein the granular viscoelastic foam has an indentation load deflection value between about 6 pounds and about 18 pounds.

14. A cushioning apparatus according to claim 1, wherein the granular viscoelastic foam has a length between about 0.078 inches and about 1.17 inches.

15. A cushioning apparatus according to claim 1, wherein the filler material further includes a material selected from the group consisting of polystyrene beads, polyester fiber balls, micro denier, latex foam, polyurethane foam, feathers, and cotton.

16. A cushioning apparatus according to claim 1, wherein the granular viscoelastic foam comprises at least about 25% of the filler material by weight.

17. A method of manufacturing an improved cushioning apparatus comprising the steps of:
a. providing a base layer comprising a plurality of panels secured together in the desired shape of the apparatus;
b. providing a plurality of chambers within the base layer, with each chamber defining an internal cavity designed to receive filler material;
c. inserting filler material comprising granular viscoelastic foam into each cavity;
d. sealing the filler material within the cavities;
e. providing a top buffer layer comprising a uniform slab of material;
f. affixing the top buffer layer to the base layer.
